(19) United States
(12) Patent Application Publication
(10) Pub. No.: US 2009/0063633 A1
(43) Pub. Date: Mar. 5, 2009

(54) REMOTE PROGRAM PRODUCTION

(76) Inventors: William Buchanan, West Sussex (GB); Russell Bradbury, London (GB)

Correspondence Address: KOPPEL, PATRICK & HEYBL, 555 ST. CHARLES DRIVE, SUITE 107, THOUSAND OAKS, CA, 91360, US

(21) Appl. No.: 11/573,679

(22) PCT Filed: Aug. 15, 2005
(86) PCT No.: PCT/GB2005/003186

§ 371 Date: Feb. 27, 2008

(30) Foreign Application Priority Data
Aug. 13, 2004 (GB) 0418152.5

(51) Int. Cl. G06F 15/16

(52) U.S. Cl. 709/205

(57) ABSTRACT

A method of compiling an audio/video work from a plurality of pieces of editable material via a computer network comprising a central server and one or more remote stations, the method comprising storing as said pieces of editable material together with information unique to each piece of material and timing information; providing data representing said material and information to a user at a remote location via the computer network according to requests received from the user; selecting editable material or portions of said editable material and noting the information associated with the selected material or portions of said material; and forwarding the noted information to the central server where the noted information is stored for further use.

The present invention relates to a method and system for the production and editing of audio-visual programs based on libraries of diverse media materials.

It is known to provide remote production systems in which a server facility can be accessed from remote locations via a computer network by users wishing to produce a program. For instance, in WO 02/03697 a system is described in which remote producers can connect to a server in order to produce programmes or information sequences for broadcast from the server to viewers of a television network. The information sequences produced by the remote producers may use information which is previously stored in the server device or which is transmitted to the server device. The “production” of programmes referred to in WO 02/03697 is principally the selection of one of various available sources at various times, and is aimed for instance at community television stations where different members of the community may, from time to time, control what is being broadcast on a particular channel.

The present invention provides a method of compiling an audio/video work from a plurality of pieces of editable material via a computer network comprising a central server and one or more remote stations, the method comprising storing as said pieces of editable material together with information unique to each piece of material and timing information;

providing data representing said material and information to a user at a remote location via the computer network according to requests received from the user; selecting editable material or portions of said editable material and noting the information associated with the selected material or portions of said material; and

forwarding the noted information to the central server where the noted information is stored for further use.

It should be noted that the “computer network” may be any means by which the central and user devices may communicate and includes dial-up connection, other telecommunication connections (including satellite and broadband) and wireless and wired links, and includes the internet and world wide web.

In a preferred embodiment, the invention provides a remote production system in which server means stores audio-visual materials for use by users connected to the server from remote locations. This may be in the form of one or more diverse libraries of media. To facilitate use of the system at least some of the material is preferably stored in both higher and lower information content forms. The higher information content form may simply be the original source material itself, or may be a further form of the material, for instance a high quality digital representation of original material stored in analogue form, for instance on a film reel.

During the preparation of a programme by a user, the lower information content forms of the stored material may be used. This enables the material either to be downloaded to a client device, which may be a static intelligent device or mobile receiving device, for handling or to be utilised in real-time over the connection to the server even when the connection from the user to the server has a relatively low bandwidth. (This permits ‘globalisation or outreach of the material to a diverse range of remote communities.). The material stored at the server has further data linked to it such that once a user has completed a programme on the basis of the lower information content material, a final version of the programme may be created using the corresponding higher information content (or originating master) material or selections therefrom as determined by the user.

The further data stored with the library material is timing or other information necessary to provide the synchronisation or binding between the lower and higher information content material and may also include information relating to the content of the material or outsourced information related and cross indexed which enriches that media content and may enable users to search for material.

As will be explained in more detail below, in the preferred implementation of the invention the system further includes means by which the data associated with the stored information (referred to below as metadata) maybe created and edited.

The concept of higher and lower information content versions of the information stored at the server may have different meanings in relation to different types of stored material. The higher information content version is generally suitable for incorporation into the finally produced programme and may be up to broadcast quality. For video information this may mean high quality video, high-definition or high resolution images including stills or other relative media content. For audio information this may mean mono/full stereo or surround-sound tracks up to the latest professional audio industry standards for instance.

The lower information content version is suitable for transmission to the remote user over the network connection which may have a relatively low bandwidth such as a modem connection/radio or other air borne system/remote satellite link via the internet. This version contains sufficient information to enable the user to do the editing and production as described and may, in the case of video material, be compressed and encoded or simply be of a lower resolution, or, in the case of audio information, be a lower quality version or a mono track in compressed format.

The present invention will be better understood from the following description of a preferred embodiment given by way of example and in conjunction with the accompanying figures, in which:

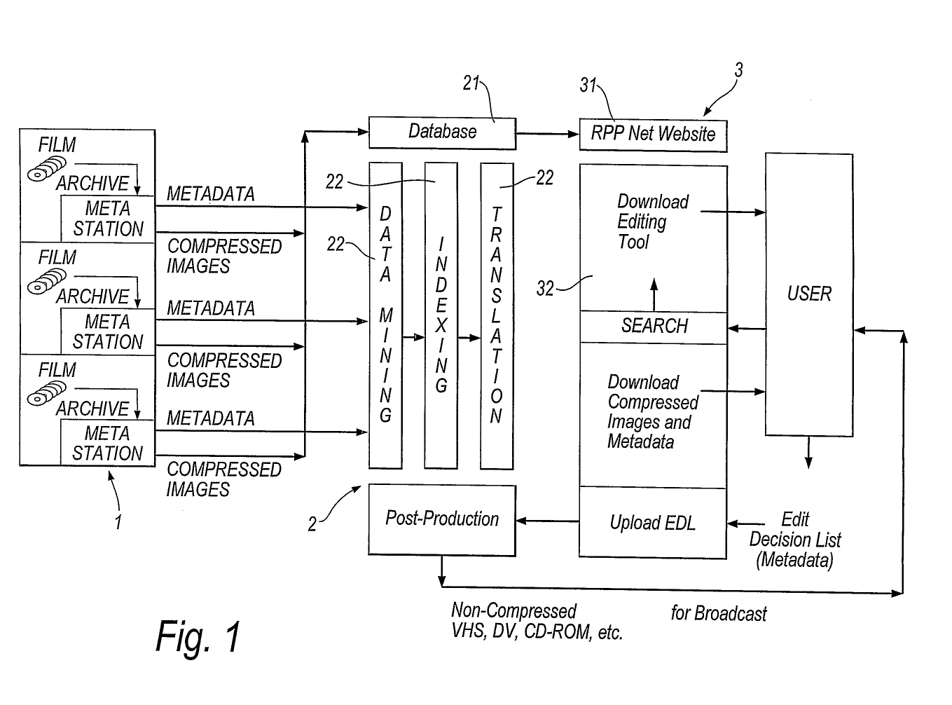

FIG. 1 which shows a schematic functional illustration of the preferred embodiment; and

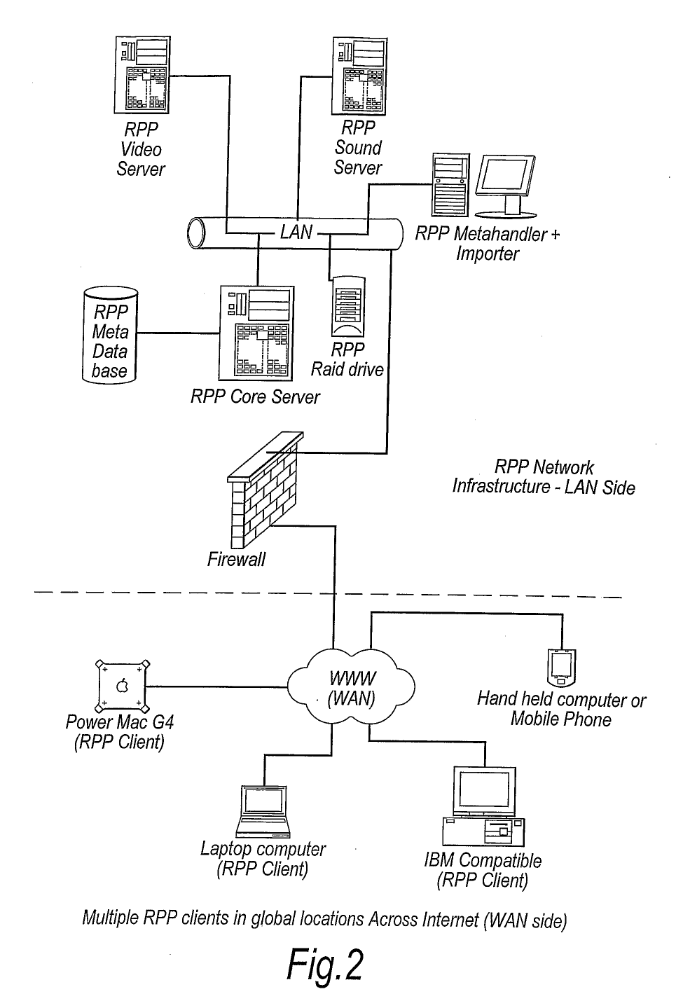

FIG. 2 is a schematic representation of certain hardware elements used to implement the invention.

The preferred embodiment of the present invention which will be described in detail below is a remote film or TV programme production system which enables a user remotely to access and select from one or more databases of source material from which to construct a programme. As will be described in more detail below, in the preferred embodiment facilities are provided to enable the user to search for and locate material relevant to a particular interest in making the programme and also provides various tools to facilitate the production of the programme while producing a high quality output product.

As illustrated in FIG. 1, the system can be considered to be formed of three basic elements, the material preparation system 1 (ingest system), the storage system 2 and an interface system 3 to which a user 4 connects. In broad terms the storage system 2 is the archive which holds the material which the user may access and select from in the production of his programme and user access to the storage system is provided by way of the interface 3. Different users may have different levels of access to the system enabling them to perform only certain actions and/or access only certain parts of the stored data. This may be achieved for instance by defining a number of security levels and assigning a level to each user, or may be individually defined for each system user. The material stored in the storage system 2 is prepared by the preparation system 1. These parts will be described in more detail below.

Material Preparation System 1 is arranged to prepare the material which is to be stored in storage system 2 for use by users. As illustrated, by way of example, in FIG. 1 this may receive audio visual information from a film archive which is to be stored in this storage system 2. As is illustrated schematically in FIG. 1, the material preparation system 1 performs two basic functions. Firstly it subjects the input film to image processing in order to generate compressed images, or other lower information content images of the original input as described above. These are stored in the database within the storage system 2 so as to be available to users utilising the system.

In addition to the generation of the compressed images, the material preparation system 1 is used to generate additional information which is termed herein “Metadata”. In general terms, the Metadata is provided and stored within the storage system 2 to enable a user of the system to access the materials (facilitating indexing search and retrieval) stored in the system and to provide the link or binding from the lower information content material to the original higher information content material. The Metadata may therefore contain timing information relating to the material stored in the storage system 2 in order to provide this binding function. Alternatively, markers or identifiers may be associated with each frame or other section of the material, with corresponding markers or identifiers being used in both the lower and higher information content material. It may also define other attributes of the material, such as the slices or clips of material which may be selected by a user to be incorporated into a production. Additionally the Metadata may represent information about the content of the material, possibly in a text based or numerically coded form, to enable a user to search for material of interest.

The Metadata may, as will be described further below, be editable by certain users and may include many different kinds of information about the material in the system. For instance the metadata may contain information containing which selection of clips has been used in combination previously or any other parameters which may be considered useful to users of the system. As described in more detail below, this may include the ability to add extra meaningful attributes/data as an example this may be an academic researcher who has found new facts of historical interest and therefore will complement that originating Metadata.

The storage system 2 illustrated in FIG. 1 is illustrated schematically as including a database portion 21 in which the lower information content material, decompressed images in this example, is stored ready to be accessed by a user. The storage system 2 additionally includes some data handling portions 22 which are arranged to provide various functions which enable a user to access and utilise the system. For instance, as illustrated, the function of indexing the Metadata may be provided to provide basic more complex index access to the data and material stored in the system. Additionally some translation, possibly multilingual, may be provided to enable use of the system in conjunction with other languages. Finally, as illustrated in FIG. 1, a data mining function may be provided to further enhance the use of the system to a user.

As mentioned above, the final part of the system illustrated in FIG. 1 is the interface generally designated by numeral 3. In general terms this interface enables a user to access the data stored in data storage system 2 and provides software tools to enable use of that data by the user. In the preferred embodiment the user may be at a remote location from the location of the server and in this case the software tools provided to the user to enable use of the system are provided at the client or user site, and it is simply the data which transferred between the user site and the database. As mentioned above, it is for this reason that the invention is capable of working in the first instance using lower information content material in order to reduce issues created by limited bandwidth between the user and database sites.

Preferably the remote access for a user is provided via a website 31 although the access may be by any other system of remote access, for instance a remote direct dial-in system or other remote and/or portable means of access.

As illustrated schematically in FIG. 1 the client software 32 provides a range of functions for the user. Firstly it may provide a simple search function which may enable a user to input one or more search terms to try to locate material of interest in the database and which works in conjunction with the database to locate the material potentially of interest. The lower information content material located in this way can then be downloaded to the user and edited as required using standard or custom editing tools. This may simply permit the selection of what lengths of the stored material are to be used in the user's production or may permit advance editing such as the application of the image or sound processing to the basic stored material in any known manner.

Other mechanisms for accessing data stored in the database may be provided, for instance it may be possible to access a stored piece of material simply by a unique identifier of that material if such is known to a user. Alternatively it may be possible to search the data according to the name of the source material or by an author or director or other person associated with the original material. The interface system may also be designed to assist new users of limited skills capacities to ‘guide’ and assist them in a relatively intelligent manner in locating the source material they may require.

The user interface system is such that each occasion the user decides to select a piece of material and each occasion the user decides to start and/or stop the selection of the exact sequence within the select material, information relating to each decision is transmitted to the central server. In this way, the EDL is created at the central server and it, as well as each individual decision, is available to any collaborator. In this way, real time collaboration can be achieved although the collaborators may be in different locations.

Data relating to all decisions may be stored at the remote location as well as at the central server. The decisions can be added to or replace any existing decisions either locally generated or downloaded from the central server until eventually a completed, compiled program has been achieved. Thus, it will be apparent that the EDL, during compilation, can exist on both the central server and each remote location. The central server will maintain and update the current EDL.

Once a user has completed his selection of material and any other processing in order to construct his production software 32 generates an edit decision list (EDL) which in its simplest form will include the information binding the selected lower information content material to the corresponding higher information content material. If the user has been able to apply more advanced editing functions to the material as mentioned above the EDL also includes the definition of this processing. At the end of the production process, the EDL is uploaded from the user to the storage system 2 which utilises the data in the EDL to construct the desired production from the higher information content material originally provided. This high quality final production may be output in any desired form, for instance on a storage media such as a magnetic tape, DVD or hard disk storage or may be provided as a broadcast standard signal for broadcast to one or more users.

It will be appreciated from the above description that an important feature of this invention is the Metadata which is provided along side the basic material to enable the system to be used in a convenient and meaningful manner by users. In conjunction with the Metadata there may be provided, in some implementations of the invention, a Metadata editor which may be used by at least some users either locally or remotely dependent upon their abilities and access rights to the system.

As mentioned above, the basic Metadata is prepared when the material is first stored in the system by the material preparation system 1 and this includes at least basic timing information relating to the material.

The Metadata editor may additionally be provided at the user side to enable a user, with suitable authorisation to do so, to modify the Metadata stored with the material on an ongoing basis. In general terms therefore it may be the case that, in addition to the basic timing material provided initially, users gradually build up Metadata relating to the content or quality or usefulness or other parameters of the material in the Metadata. This may be particularly useful for instance in the academic or medical field where users may add information to the Metadata relating to new information relating to particular drug applications for instance or other advances in a particular medical discipline (following on from new lines of research). This additional Metadata can be added and updated without the need to recapture and re-index the basic original material, and can be added to from remote global locations.

As material is compiled by a user sending an EDL to the server, this EDL can be used to form a file accessible to other users. This file can be in any convenient format e.g. Advanced Authorising Format.

FIG. 2 illustrates certain hardware elements present at the server and client side of the system of the invention and the functions which this may perform.

It is envisaged that this invention will have a wide range of uses. As described above it can be initially thought of in terms of film production from a database of stored material. It is believed that this new system can advantageously open up the production of broadcast quality material to a larger number of categories of user than have been possible previously and it may be used by schools or colleges for educational programmes (including facilities with pupils with learning difficulties or special needs), medical messages for public information, advertising and other related media agencies, or minority groups. As many users can access the system, even those in remote locations who may which to assist in the ‘globalisation’ of their communities, it permits collaboration by multiple users on the construction of audio visual programmes with the users being at multiple remote locations possibly distributed around the globe. It also permits collaboration of the manipulation of the material for educational, research, diagnostic, entertainment, advertising, training or other audio visual purposes.

The system may further monitor the usage of the stored material to allow for tracking and payment of royalties by the users to copyright holders in the original material and this may be done on the basis of country specific information relating to different licensing or copyright arrangement in different countries.

It is believed that, in the preferred embodiment, advantages are provided by the bringing together of a number of different developments including:
1. Cost effective semi-automated description and indexing of larger amounts of audio visual content.
2. The ability to search large databases of this content by utilisation of the Metadata to bring fast meaningful search results very useful to the user.
3. The system of standardisation of content file types with unique time coding to allow different material to be utilised in a single production in particular by use of the EDL.
4. The ability then to automatically generate a broadcast quality version of the users edited production.

It will be apparent that many other applications are available for this basic system and this invention is not intended to be limited to any particular use of the system.

1. A method of compiling an audio/video work from a plurality of pieces of editable material via a computer network comprising a central server and one or more remote stations, the method comprising:
storing as said pieces of editable material together with information unique to each piece of material and timing information;
providing data representing said material and information including content information relating to the content of the editable material to a user at a remote location via the computer network according to requests received from the user;
searching the material using the content information;
selecting editable material or portions of said editable material and noting the information associated with the selected material or portions of said material; and
forwarding the noted information to the central server where the noted information is stored for further use characterized that the content information is editable by a user in order to permit user defined information to be added to the content information.

2. The method according to claim 1, in which said timing information comprises corresponding time codes applied to said first and second versions.

3-5. (canceled)

6. A method according to claim 1, wherein the data representing said material is provided to a user as lower bandwidth material than the stored material.

7. The method according to claim 6, in which said lower bandwidth material is of a quality suitable for at least real-time transmission via said computer network.

8. The method according to claim 1, in which said stored material is of broadcast quality.

9. The method according to claim 1, wherein each time a user notes a decision relating to at least one of said pieces of material, information relating to the decision is forwarded to the central server whereby an edit decision list is created at the central server.

10. A system of compiling an audio/video work from a plurality of pieces of editable material via a computer network, the system comprising:
a central server and one or more remote stations, the central server having means for storing said pieces of information together with information unique to each piece of material and timing information,
user operatable means at a remote station for communicating with the central server via the computer network in order to request data representing editable material to be sent to the remote station,
user operable means for noting information associated with user selected material or portions of said editable material, and
means for forwarding the noted information to the central server which is additionally provided with storage means for storing said noted information for future use, wherein the noted information is editable by a user in order to permit user defined information to be added.

11. The system according to claim 10, in which said additional information comprises corresponding time codes applied to said first and second versions.

12. The system according to claim 10, in which said additional information comprises content information relating to the content of the editable material.

13. The system according to claim 10, further comprising output means arranged to output said work.

14. The system according to claim 13, in which said output means comprise means arranged to broadcast said work.

15. The system according to claim 13, which said output means comprises means arranged to write said work to a recording medium.

16-22. (canceled)
